(19) United States
(12) Patent Application Publication
(10) Pub. No.: US 2017/0026843 A1
(43) Pub. Date: Jan. 26, 2017

(54) PREVENTION OF COVERT ACCESS AFTER SUCCESSFUL COMPLETION OF AUTHENTICATION PROCESS

(71) Applicant: Mercury Systems, Inc., Chelmsford, MA (US)

(72) Inventors: Robert V. Lazaravich, Chandler, AZ (US); Daniel P. Fogelson, Chandler, AZ (US)

(73) Assignee: Mercury Systems, Inc., Chelmsford, MA (US)

(21) Appl. No.: 15/216,138

(22) Filed: Jul. 21, 2016

Related U.S. Application Data
(60) Provisional application No. 62/195,271, filed on Jul. 21, 2015.

(51) Int. Cl. H04W 12/08; H04W 12/02; H04W 12/06

(52) U.S. Cl. CPC H04W 12/08; H04W 12/06; H04W 12/02

(57) ABSTRACT

Various security systems in which secure data is to be transferred to an authenticated device may benefit from methods of securing such data transfer. For example, certain secure drives or other memory devices may benefit from the prevention of covert access after successful completion of an authentication process. A method can include monitoring for a loss-of-link condition for a link associated with a successfully executed authentication operation. The method can also include determining that the link has been lost. The method can further include taking a security response based on the determination that the link has been lost.

### CROSS REFERENCE TO RELATED APPLICATIONS

This application claims priority to U.S. Provisional Patent Application Ser. No. 62/195,271 filed Jul. 21, 2015, titled, “Prevention Of Covert Access After Successful Completion Of Authentication Process,” the disclosure of which is fully incorporated herein by reference for all purposes.

### DESCRIPTION OF THE INVENTION

Field Of the Invention

The present invention relates to systems and methods for securing data transfer between devices, more particularly, there are provided systems and methods for preventing covert access after successful completion of an authentication process.

Background of the Invention

Many security products require some sort of authentication before allowing a user free access. Some products, for example, secure encrypting hard drives or solid state drives (SSD), may use a password, key fob, or some other form of authentication/identification. Once the authentication process is completed, the product begins normal operation and allows free usage and/or access.

Considering the case of an SSD or hard drive, there may be a type of security risk present after authentication is completed. Specifically, the attacker could remove the data interface cable and re-insert it into a different laptop or other computer device for the purpose of covertly monitoring, reading, modifying, writing, or copying the contents of the drive.

Conventionally, this security risk is ignored. Thus, many conventional drives and other products may be vulnerable to this type of attack. Alternatively, some security systems may constantly or periodically require a re-authentication operation with the user. This re-authentication technique can lower data transfer bandwidth if the authentication is too frequent, and it can become annoying to the user, requiring constant or even periodic authentications to check if the user is still present. Additionally, depending on the type of system, the user may not be physically close to the security device, and consequently might not be able to see or detect that an attacker is moving an interface cable to access sensitive data.

### SUMMARY OF THE INVENTION

According to certain embodiments, a method can include monitoring for a loss-of-link condition for a link associated with a successfully executed authentication operation. The method can also include determining that the link has been lost. The method can further include taking a security response based on the determination that the link has been lost. The security response may be further contingent on evaluating an indicator signal to determine whether the link has been compromised, and in various embodiments, the indicator signal may be evaluated after the determination that the link has been lost, and in alternate embodiments, the indicator signal may be evaluated regardless of whether there has been a determination that the link has been lost. In yet another embodiment, the security response may be further contingent on determining that the link has been lost for at least a threshold amount of time. Also, certain embodiments of the present invention provide that the security response may be further contingent on determining that a parameter associated with the link has changed, and the parameter may comprise at least one of a capacitance, a voltage, a current, a resistance, an inductance, a temperature, a vibration, a cable length, or switching noise. Further, and embodiment provides that the security response may comprise signaling that an attempt to bypass security has been detected. All of the aforementioned methods may be implemented in various configurations with circuitry and component structures defined below.

In certain embodiments, an apparatus can include circuitry configured to monitor for a loss-of-link condition for a link associated with a successfully executed authentication operation, and to determine that the link has been lost. The apparatus can also include circuitry configured to take a security response based on the determination that the link has been lost.

An apparatus, according to certain embodiments, can include means for monitoring for a loss-of-link condition for a link associated with a successfully executed authentication operation. The apparatus can also include means for determining that the link has been lost. The apparatus can further include means for taking a security response based on the determination that the link has been lost.

### BRIEF DESCRIPTION OF THE DRAWINGS

For proper understanding of the invention, reference should be made to the accompanying drawings, wherein:

FIG. 1 illustrates various methods according to certain embodiments.

FIG. 2 illustrates a possible attack scenario.

FIG. 3 illustrates a response to an attack scenario, according to certain embodiments.

FIG. 4 illustrates another method according to certain embodiments.

FIG. 5 illustrates a system according to certain embodiments.

### DETAILED DESCRIPTION:

Both the foregoing summary and the following detailed description are exemplary and explanatory only and are not restrictive of the invention as claimed. A more complete understanding of the present invention may be derived by referring to the detailed description and claims when considered in connection with the following illustrative figures.

Certain embodiments may address the above-described security risk, as well as other security risks. In certain embodiments, a product can maintain a link connection to a host system. Bit errors on the interface between the product and the host system can cause the product to lose the link connection momentarily. The loss-of-link can occur randomly and may generally be of short duration.

The product can work to automatically restore the link as soon as possible. Whenever the link to the host system is lost, disconnected, or unsynchronized, the cause might not be a bit error, but instead the cause might be that an attacker has moved the interface cable to another computer or device in order to access sensitive data in the secure device. Thus, in certain embodiments, the loss-of-link connection can be used as a first indicator to determine that an attack of the system is in progress.

Accordingly, a loss of link condition can refer generally to any situation in which there is a loss of a connection or loss of a communication link. For example, a loss of link condition can refer to a situation in which physical layer communication fails to operate correctly for any reason. This loss of link condition may be due to bit errors, as noted above, or due to manipulation of a cable or the like. Failure at other layers of a communication stack, such as failures at an application layer, can also be used as indicia of a loss of link condition.

Various physical interfaces are possible. For example, the interface cables between the host system and the product may normally couple a plurality of pins to ground. In certain embodiments, one of the normally grounded pins can be selected. The pin can be utilized as an indicator signal to an input of the controller that controls drive operation. A pull up resistor can be coupled to the selected pin, so that if the interface cable is removed, the pull-up resistor will pull the indicator signal on the selected pin from a low level to a high level.

In normal operation, the controller may be designed to ground the selected pin, meaning drive the indicator signal to a 0 V level, i.e. a near ground level, to maintain the best signal integrity. Alternatively, the controller may be designed to constantly or periodically monitor the indicator signal depending on a specific implementation. If the indicator signal is ordinarily being driven to a 0 V level by the controller, then there can be a way to determine when to unground the selected pin, and then evaluate a current state of the indicator signal.

If the controller keeps the indicator signal grounded or otherwise driven low and waits for a loss-of-link event to occur, the controller can then decouple the selected pin from a ground connection and sample the state of the indicator signal to determine if the event is a bit error or an actual attack. Taken together, these events can be used to determine if the cable was removed and that an attack is in progress.

In addition to the approaches described above, it is also possible to determine that an attack is in progress by comparing previously measured and saved or other reference electrical parameters of the host system, as compared to current parameters of the host system. Parameters can include, for example, capacitance, resistance, inductance, voltage, current, cable length, temperature, and switching noise. Switching noise may be caused by, for example, cable movement. Other parameters can also be used. Any parameter differences measureable in the original host system compared to that of the current or attacking host can be used to help make or validate a determination that the current host system is not the previously authenticated host system.

There can be a variety of implementations. For example, in a physical implementation, there can be an indicator signal that is a signal that replaces a single ground pin on a prior art serial advanced technology attachment (SATA) connector. SATA cables typically tie all ground pins together to a common ground. This allows one or more of the pins, normally grounded in a SATA connector, to be used to carry an indicator signal. For example, a pull-up resistor can be added. A SATA link to a host system may be capable of generating a signal, which can indicate when the link to the host system is lost. Firmware can monitor the new indicator signal and take an action/penalty when an attack is detected.

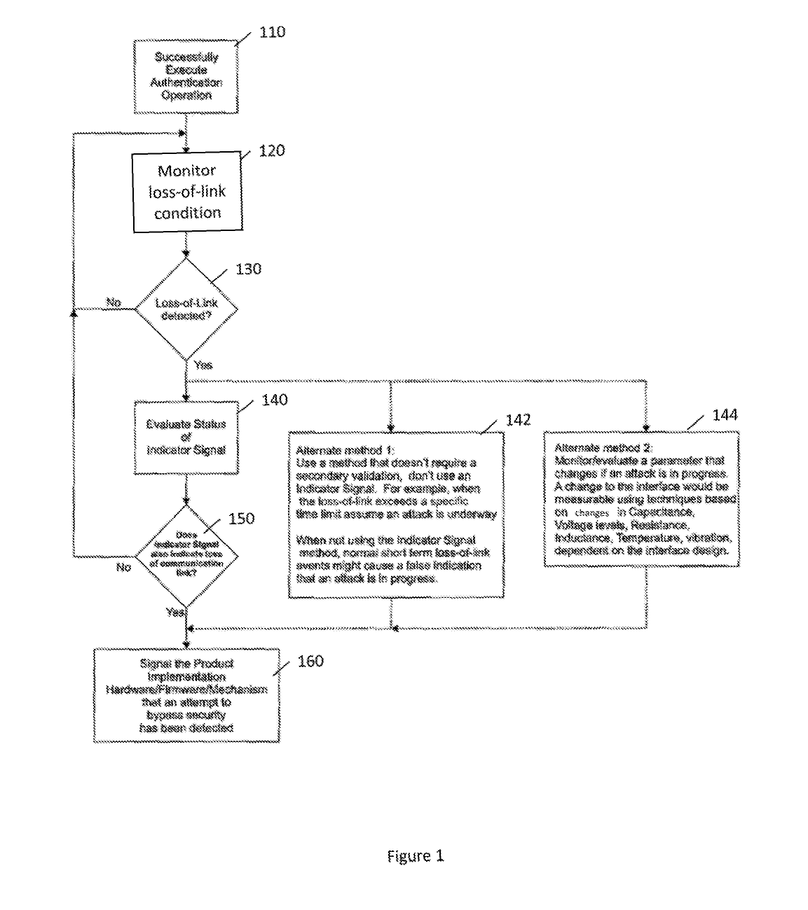

FIG. 1 illustrates various methods according to certain embodiments. As shown in FIG. 1, at 110 an authentication operation can be executed successfully. Then, at 120, monitoring may be performed for a loss-of-link condition. At 130, it can be determined whether a loss-of-link condition has been detected. If not, monitoring can continue at 120. If a loss-of-link condition is detected, at 140, the status of an indicator signal can be evaluated. If it is determined, at 150, that the indicator signal does not indicate a loss of the link, then the system can continue to monitor at 120. Otherwise, if it is determined, at 150, that the indicator signal indicates a loss of the link, the system can, at 160, signal that an attempt to bypass security has been detected.

As shown in FIG. 1, certain alternative methods can be used. For example, at 142, a determination can be made without requiring a secondary validation, such as an indicator signal. One potential consequence of using this approach, as noted in FIG. 1, is that normal short term loss-of-link events may cause a false indication that an attack is in progress.

As another alternative, which may be in addition to or as an alternative to the indicator signal approach, at 144, the system can monitor and/or evaluate a parameter that changes if an attack is in progress or has already occurred. A change to the interface, indicating that an attack is in progress or has already occurred, may be detected based on measuring changes in capacitance, voltage levels, resistance, inductance, temperature, vibration, and the like, dependent on the interface design. Various hardware elements may be used to support such detection. For example, various sensors, such as inductance meters, touch-sensitive elements, gyroscopic elements, micro-electro-mechanical systems, piezoelectric systems, and the like can be used to detect tampering.

Other mechanisms can also be employed to detect tampering at the interface. For example, the receptacle for receiving the cable may be provided with a sensor that detects whether the cable is installed in the receptacle. This may be an optical sensor that detects when there is an unbroken path of light between an LED on one side of the cable and a photodiode on the other side of the cable, an ultrasonic or other ranging sensor that detects the proximity of one side of the cable to the sensor, or any other sensor for detecting the presence or absence of the cable at the interface. The same or similar mechanisms may be applied, if desired, at the host end of the cable, to prevent an attacker from avoiding detection by removing the host end of the cable interface. These mechanisms may be employed as alternatives or in addition to mechanisms such as detecting whether the normally grounded pins remain grounded.

Other mechanisms may similarly analyze the levels of the signal lines of the cable. For example, if high signal levels on the signal lines are at a particular voltage level initially, or during an authentication process, but begin to be present at higher or lower levels later, this may indicate tampering with the cable.

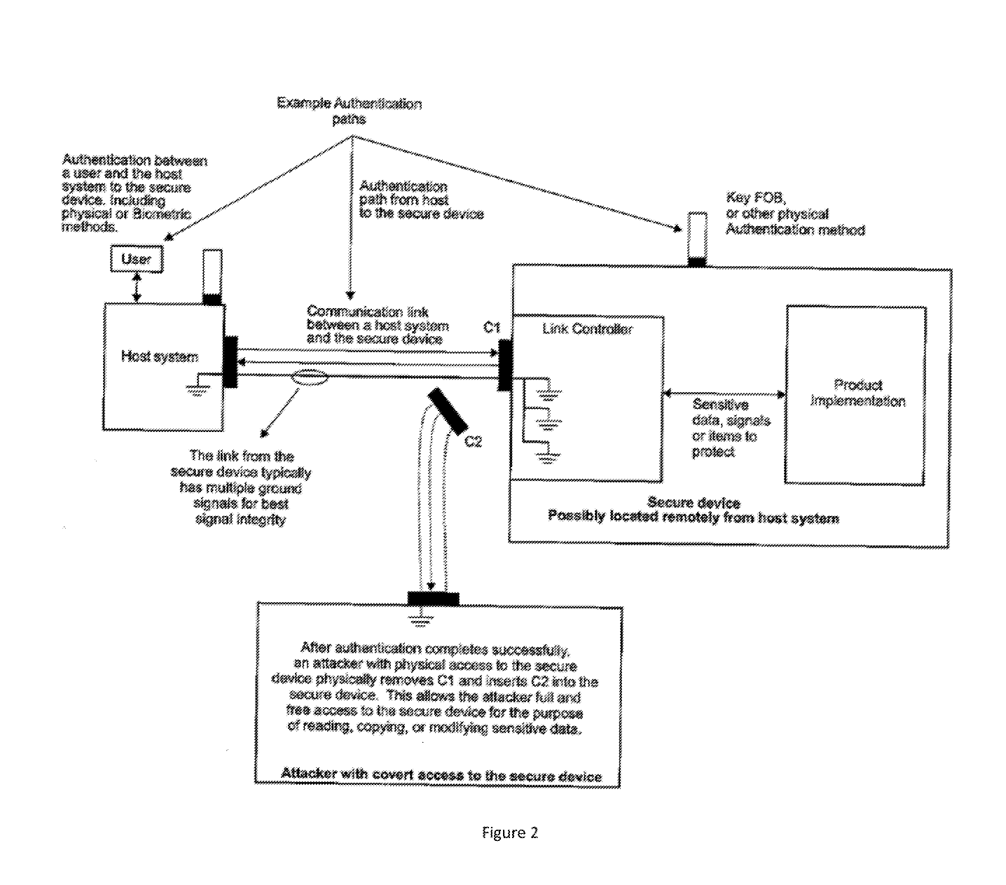

FIG. 2 illustrates a possible attack scenario. As shown in FIG. 2, there can be various possible authentication paths. The authentication paths can include authentication between a user and a host system to the secure device. Examples of such authentication can include physical or biometric methods.

The authentication path can also include an authentication path from the host system to the secure device. This can be performed over a communication link between the host system and the secure device. The link from the secure device may have multiple normally grounded signals. These multiple normally ground signals may be provided to try to provide the best signal integrity for the communication path.

Another authentication path can be directly into the secure device. A key fob or other physical authentication method can be used directly with the secure device. This approach may be used alone or in combination with the other authentication paths.

The secure device may possibly be located remote from the host system. Alternatively, the secure device may be located close to the host system. For example, the secure device may be attached by a long or short cable to the host system.

The secure device may include a link controller and other hardware and/or software for implementing a product. This product implementation may be a secure solid-state drive. The product implementation may include one or more processors and one or more memory including, for example, firmware.

The product implementation may communicate sensitive data, signals, or other items that are to be protected to the link controller, for transmission to the host system. Although the product implementation and link controller are shown as separate units, the product implementation and link controller may be provided as an integrated circuit, such as an application-specific integrated circuit.

The host system may be attached to the link controller at an interface using cable C1. However, after authentication is successfully completed, an attacker with physical access to the secure device can physically remove cable C1 and insert cable C2 into the secure device.

Cable C2 may be attached to an attacker's computer or other device. This substitution of cable C2 for cable C1 can allow the attacker full and free access to the secure device for the purpose of reading, copying, or modifying sensitive data.

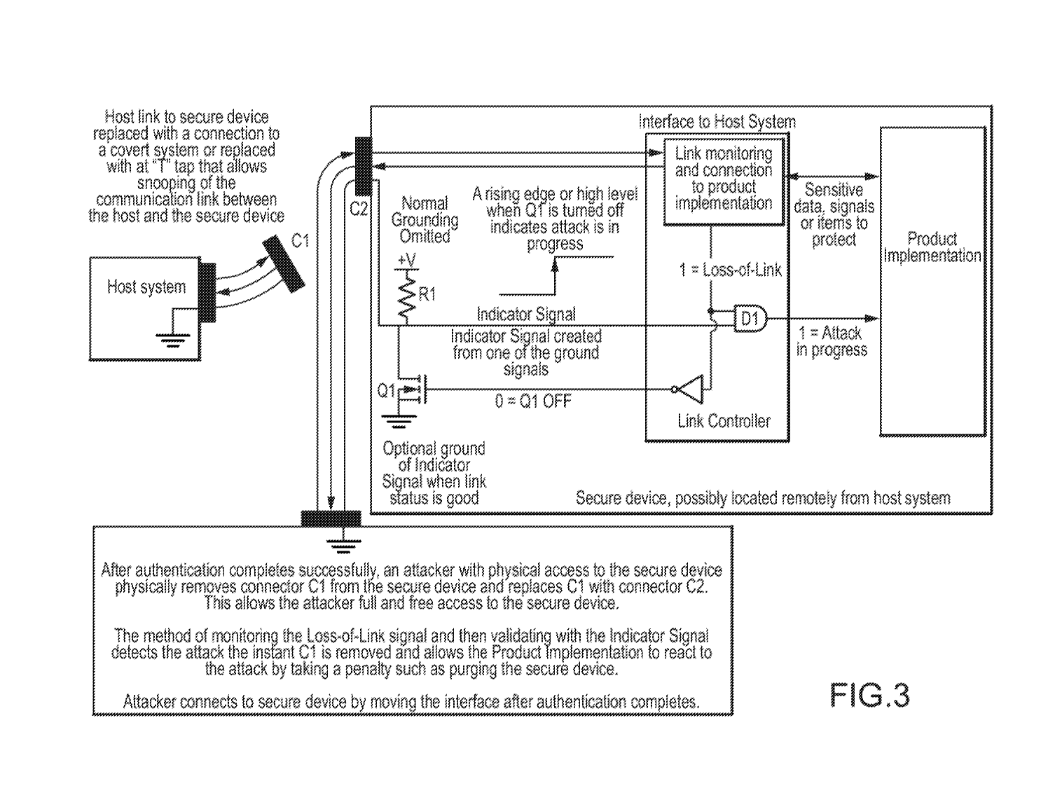

FIG. 3 illustrates a response to an attack scenario, according to certain embodiments. As shown in FIG. 3, a host's cable C1 can be replaced with a connection, such as cable C2, to a covert system. Alternatively, not shown, a “T” tap can be inserted to allow snooping between the host and the secure device. As mentioned above, this substitution of cable C2 for cable C1, or insertion of a T tap, can allow the attacker full and free access to the secure device for the purpose of reading, copying, or modifying sensitive data.

To address such an attack scenario, or for other purposes, a secure device can be provided with a particularly-configured interface to the host system. This interface may be provided in a link controller or the like. The link controller or other system can detect whether an attack is in progress and can signal the product implementation if an attack is determined to be in progress.

Alternatively, the link controller or other system can provide signals from which the product implementation can make a determination as to whether or not an attack is in progress. Other implementations are also possible.

As shown in FIG. 3, the link controller can perform link monitoring and can provide a connection to the product implementation. In certain embodiments, when a loss-of-link condition is detected, an output signal of this loss-of-link detection can be provided to a logical AND device, which is also configured to monitor for an indicator signal. When both the indicator signal and the loss-of-link detection signal are high, the logical AND device can provide an attack in progress signal to the product implementation.

As also shown in FIG. 3, the indicator signal can be measured by providing a resistor R1 connected to a voltage V and to the selected one of the normally grounded pins of the cable interface. The other normally grounded pins can be left floating or can be similarly tied to the resistor R1. If the normally grounded pins are isolated from one another, the other normally grounded pins may be left grounded. The selected pin can be attached to the drain side of a transistor Q1, with the source side of transistor Q1 being grounded. The selected pin can be connected to ground at the host system, and at the attacker device. Q1 is optional, and is not required in all implementations.

Q1 can be controlled by a signal from the link controller. Thus, when monitoring of the indicator signal is not desired, Q1 can be turned on, which can connect the selected pin to ground, thus driving the indicator signal to ground. When monitoring of the indicator signal is desired, Q1 can be turned off In the absence of Q1, the link controller can monitor the indicator signal at any, and all, times.

When Q1 is off, a rising edge or high level of the indicator signal can indicate that an attack is in progress, as it is indicative that the selected pin is temporarily not connected to ground at the host device. As noted above, this indicator signal can be combined in a logical AND gate with a loss-of-link detection signal to provide an attack in progress signal.

Other implementations are also possible. For example, the loss-of-link detection signal may be provided directly to the product implementation. The product implementation can then make a decision regarding whether to implement a security response based on the loss-of-link detection signal. For example, the security response can be based on a duration of the loss-of-link detection signal or the number of times the loss-of-link detection signal has been detected within a certain period. Alternatively, and optionally additionally, the indicator signal may be provided directly to the product implementation, and the product implementation can then make a decision regarding whether to implement a security response based on a high level of the indicator signal, with, or without, the loss-of-link detection signal.

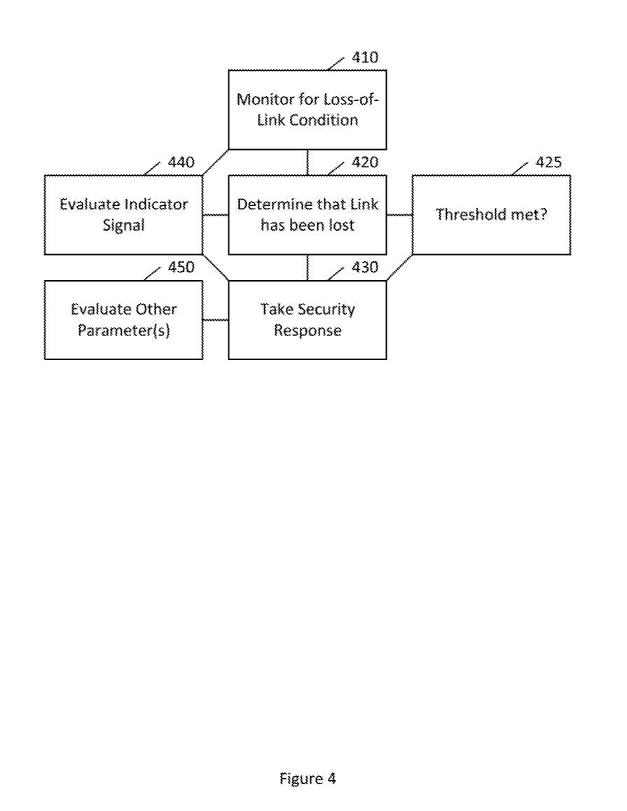

FIG. 4 illustrates another method according to certain embodiments. As shown in FIG. 4, a method can include, at 410, monitoring for a loss-of-link condition for a link associated with a successfully executed authentication operation. The previously successful authentication operation may be carried out over the link or separate from the link.

The method can also include, at 420, determining that the link has been lost. The method can further include, at 430, taking a security response based on the determination that the link has been lost. The method can additionally include, at 440, evaluating an indicator signal to determine whether the link has been compromised.

In certain embodiments, the security response can be further contingent on evaluating the indicator signal to determine whether the link has been compromised.

For example, in certain embodiments, the indicator signal can be evaluated after the determination that the link has been lost. Thus, for example, the indicator signal can be kept at ground until the determination that the link has been lost.

Alternatively, the indicator signal can be evaluated regardless of whether there has been a determination that the link has been lost. Thus, the indicator signal may be constantly or periodically evaluated even if there is no previous or simultaneous determination that the link has been lost.

The method can also include, at 425, determining whether a threshold has been met. The threshold may be, for example, a length of time that the link has been lost, or a number of times that the link has been lost within a particular timeframe. In certain embodiments, therefore, the security response can be further contingent on determining that the link has been lost for at least a threshold amount of time.

The method can also include, at 450, evaluating one or more other parameters associated with the link. Thus, in certain embodiments, the security response can be further contingent on determining that a parameter associated with the link has changed. The parameter can include at least one of a capacitance, a voltage, a current, a resistance, an inductance, a temperature, a vibration, a cable length, switching noise or a signal voltage level. Other parameters can also be measured, using a variety of sensors or other circuitry.

The security response, at 430, can include signaling that an attempt to bypass security has been detected. The security response can further include such actions as requiring re-authentication, encrypting sensitive data, wiping sensitive data, disabling communication of sensitive data, prompting a user of the host device to verify attachment of the cable, or the like.

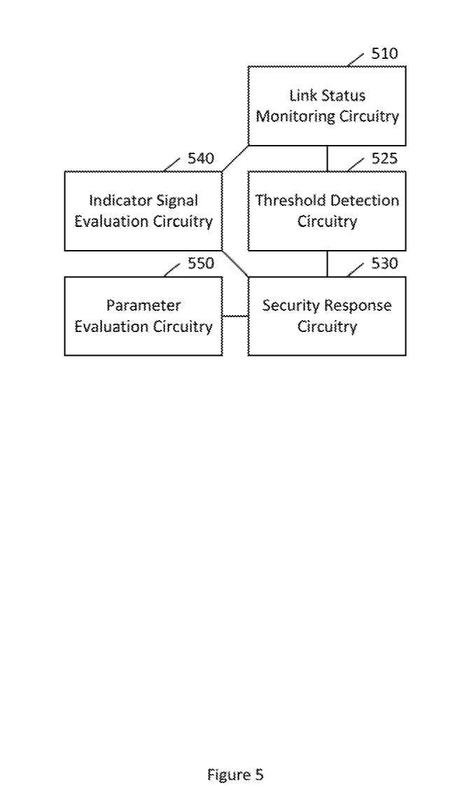

FIG. 5 illustrates a system according to certain embodiments. As shown in FIG. 5, a system can include link status monitoring circuitry 510, such as a link controller. The circuitry can be configured to monitor for a loss-of-link condition for a link associated with a successfully executed authentication operation and to determine that the link has been lost. The apparatus can also include threshold detection circuitry 525, which may include a buffer, a comparator, or the like. In some cases, the threshold detection circuitry 525 may simply detect the presence of a loss-of-link detection signal, whereas in other embodiments the threshold detection circuitry 525 may determine whether the loss-of-link detection signal meets at least one further threshold, as mentioned below.

The system can also include security response circuitry 530, which can be configured to take a security response based on the determination that the link has been lost. The security response circuitry 530 can be an output that signals a provided processor. Alternatively, the security response circuitry 530 can include a processor that can determine an appropriate security response. The security response circuitry 530 can be configured to signal that an attempt to bypass security has been detected, as one form of providing a security response.

The system can further include indicator signal evaluation circuitry 540. This circuitry can be configured to evaluate an indicator signal to determine whether the link has been compromised. The security response can be further contingent on the indicator signal. The circuitry can be configured to evaluate the indicator signal upon the determination that the link has been lost. Moreover, the circuitry can be configured to keep the indicator signal at ground until the determination that the link has been lost. An example of such circuitry can be seen in FIG. 3, where the resistor, transistor, and voltage source can be used to evaluate whether ground for the cable has been compromised, indicating that the cable has been disconnected.

Alternatively, the signal evaluation circuitry 540 can be configured to evaluate the indicator signal regardless of whether there has been a determination that the link has been lost. Thus, for example, transistor Q1 of FIG. 3 can be omitted, such that the indicator signal automatically provides a leading edge or high value as soon as ground is lost on the cable, regardless of whether monitoring has been enabled. Other sensors for monitoring are also permitted.

As mentioned above, there can be threshold detection circuitry 525. This circuitry can be configured to determine that the link has been lost for at least a threshold amount of time or at least a threshold number of times within a certain window of time. The security response can be further contingent on the link having been lost for at least the threshold amount of time.

The system can also include parameter evaluation circuitry 550. This circuitry can be configured to determine that a parameter associated with the link has changed. The security response can be further contingent on determining that the parameter associated with the link has changed. The parameter can be or include at least one of a capacitance, a voltage, a current, a resistance, an inductance, a temperature, a vibration, a cable length, switching noise, or any combination thereof.

Certain embodiments may have various benefits and/or advantages. For example, certain embodiments may provide a reliable way to test for an attack, such as a cable-switching attack. In response to the attack event, a security controller can respond by requiring another authentication, erasing the entire drive, or whatever penalty makes sense for the particular application. Other security responses are also possible.

While it is possible to use only the loss-of-link condition between the host and the secure device as the method to determine when an attack is happening, bit errors can occur for other reasons than an attack and some bit error events can appear to be an attack event. Thus, without some further validation, a method that focuses on a loss-of-link condition may lead to a false positive indication of an attack. Thus, in certain cases an attack penalty may be applied even though an attack has not actually occurred.

Variations of the above embodiments are also possible. For example, while certain embodiments have described first identifying a loss-of-link condition of an authenticated link, and then evaluating an indicator signal or other parameter, certain embodiments may also evaluate the indicator signal or other parameter during an authentication process. Thus, in certain embodiments the status of the indicator signal or other parameter during the authentication process may serve as a baseline for determining whether the loss-of-link is due to bit error or cable substitution or other tampering.

Another variation may be to require the existence of additional conditions before execution of the security response. There are many possible additional conditions. For example, after a loss-of-link, there may be a determination of whether the link has been restored, which may indicate that an attack is being attempted. Alternatively, there may be a determination of whether the link remains lost, which may indicate that there is interference or some other non-attack problem. Other contingencies are also possible.

Certain embodiments can have other applications where a similar authentication process is followed by free access operation, in which each successive request does not require its own new authentication. Thus, after authentication the host system may be able to read and write to a secure drive without having to re-authenticate for each read or write operation. During the free access operating mode, it may be possible to covertly divert sensitive data if control of the device, even temporarily, is lost. For example, after entering a personal identification number (PIN), thumb print, fingerprint, or the like on a cell phone, it may be considered a loss-of-link condition if the user puts the phone down. A loss-of-link condition can be detected by any way of detecting that the user is no longer holding the phone, such as infrared detection, accelerometer information, or readings of a wireless signal from a device attached to the user's body. An equivalent of the indicator signal in this scenario can be, for example, some measureable biometric unique to the authenticated user that is continuously measurable as long as the user holds the phone, such as the user's pulse or the like. Phones can use a no-activity time limit that expires as the indicator signal or can require the user to press a button to re-lock the phone.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

What is claimed is:

1. A method, comprising:
monitoring for a loss-of-link condition for a link associated with a successfully executed authentication operation;
determining that the link has been lost; and
taking a security response based on the determination that the link has been lost.

2. The method of claim 1, wherein the security response is further contingent on evaluating an indicator signal to determine whether the link has been compromised.

3. The method of claim 2, wherein the indicator signal is evaluated after the determination that the link has been lost.

4. The method of claim 3, wherein the indicator signal is kept at ground until the determination that the link has been lost.

5. The method of claim 2, wherein the indicator signal is evaluated regardless of whether there has been a determination that the link has been lost.

6. The method of claim 1, wherein the security response is further contingent on determining that the link has been lost for at least a threshold amount of time.

7. The method of claim 1, wherein the security response is further contingent on determining that a parameter associated with the link has changed.

8. The method of claim 7, wherein the parameter comprises at least one of a capacitance, a voltage, a current, a resistance, an inductance, a temperature, a vibration, a cable length, or switching noise.

9. The method of claim 1, wherein the security response comprises signaling that an attempt to bypass security has been detected.

10. An apparatus, comprising:
circuitry configured to monitor for a loss-of-link condition for a link associated with a successfully executed authentication operation, and to determine that the link has been lost; and
circuitry configured to take a security response based on the determination that the link has been lost.

11. The apparatus of claim 10, further comprising:
circuitry configured to evaluate an indicator signal to determine whether the link has been compromised, wherein the security response is further contingent on the indicator signal.

12. The apparatus of claim 11, wherein the circuitry configured to evaluate the indicator signal is configured to evaluate the indicator signal upon the determination that the link has been lost.

13. The apparatus of claim 12, wherein the circuitry configured to evaluate the indicator signal is configured to keep the indicator signal at ground until the determination that the link has been lost.

14. The apparatus of claim 11, wherein the circuitry configured to evaluate the indicator signal is configured to evaluate the indicator signal regardless of whether there has been a determination that the link has been lost.

15. The apparatus of claim 10, further comprising:
circuitry configured to determine that the link has been lost for at least a threshold amount of time, wherein the security response is further contingent on the link having been lost for at least the threshold amount of time.

16. The apparatus of claim 10, further comprising:
circuitry configured to determine that a parameter associated with the link has changed, wherein the security response is further contingent on determining that the parameter associated with the link has changed.

17. The apparatus of claim 16, wherein the parameter comprises at least one of a capacitance, a voltage, a current, a resistance, an inductance, a temperature, a vibration, a cable length, or switching noise.

18. The apparatus of claim 10, wherein the security response comprises signaling that an attempt to bypass security has been detected.

19. The apparatus of claim 10, wherein the circuitry comprises at least one normally grounded pin having a detection circuit coupled thereto, wherein the detection circuit is configured to pull the normally grounded pin up to a high voltage level when the link has been lost due to physical disconnection of a cable for the link, wherein the high voltage level is configured to provide an indicator signal indicating that the link has been compromised.

20. An apparatus, comprising:
means for monitoring for a loss-of-link condition for a link associated with a successfully executed authentication operation;
means for determining that the link has been lost; and
means for taking a security response based on the determination that the link has been lost.

21. The apparatus of claim 20, wherein the security response is further contingent on evaluating an indicator signal to determine whether the link has been compromised.
